(19) United States
(12) Patent Application Publication
(10) Pub. No.: US 2019/0126227 A1
(43) Pub. Date: May 2, 2019

(54) CATALYST LOADING METHOD TO DISPERSE HEAT IN HYDROCONVERSION REACTOR

(71) Applicant: Saudi Arabian Oil Company, Dhahran (SA)

(72) Inventor: Omer Refa KOSEOGLU, Dhahran (SA)

(21) Appl. No.: 15/797,371

(22) Filed: Oct. 30, 2017

(51) Int. Cl. B01J 8/02; B01J 29/06; C10G 47/02

(52) U.S. Cl. CPC B01J 8/0285; C10G 47/02; B01J 29/06

(57) ABSTRACT

The invention relates to a method for modulating and controlling heat produced during an exothermic catalytic reaction. By combining two or more catalysts with differing activation energies, one can control the amount of heat change produced while the action proceeds. Among the advantages of such a process is the control of temperatures so that the change is within reactor tolerance.

### FIELD OF THE INVENTION

The invention relates to methods for improving the catalytic processing of hydrocarbon feedstocks. More particularly, it deals with improving the ability to control heat generation by catalytic systems, which in turn leads to the ability to optimize process technology with pre-existing reactor structures.

### BACKGROUND AND PRIOR ART

The processing of hydrocarbon feedstocks by, e.g., the petrochemical industry, is complex. One feature of essentially all feedstock preparation methodologies is the use of reactors, and catalysts which are placed in the reactors, so as to, e.g., hydrocrack, demetallize, desulfurize, denitrogenate, reform, etc., the particular feedstock used.

Catalytic reactions require the application of heat, and reactors are designed and built with specific heat tolerances. The tolerances, which vary, generally range between 25° C. and 40° C. In other words, if a reaction takes place at a starting temperature of “X,” (“start of run” or “SOR” temperature) the reactor can accommodate a temperature of from “X+25° C.” to “X+40° C.,” before there are issues with reactor malfunction.

Catalytic reactions that consume hydrogen are exothermic. The implication of this, for refining processes and for petrochemical processing, are that the artisan has to balance the tolerances of the reactor being used, and the heat produced during the exothermic reactions.

One way the field has adapted to these issues is to build “cooling” or “quenching” zones in between the beds on which catalysts are applied, and function. These quenching zones can be simple, or complex; however, their purpose is the same: to reduce the amount of heat carried by reactants in a reactor.

Catalysts are known to have an activity temperature range, i.e., a temperature minimum necessary to function for targeted conversion and activation energies, i.e., activity response to temperature changes. The activation energy is a well known parameter, calculated from Arrhenius' equation. To elaborate, a high activation energy means that, when plotting values from the Arrhenius equation, the slope is steeper than with low activation energy, and the system responds to temperature changes more rapidly than a system with low activation energy. Generally, catalysts which are based on zeolites have lower activity temperatures and higher activation energies than amorphous catalysts do.

These activity temperatures, it can be seen, are relevant to the artisan who is trying to develop a protocol for carrying out a reaction. If that artisan is using a reactor which, e.g., has a tolerance of 400° C., and a zeolite catalyst with an activity temperature of 350° C., then that artisan has 50° C. of “leeway” before reaching the end of run temperature.

The temperature increase experienced by a given catalyst in a given reaction can be measured experimentally, and activation energies are well known. Hence, with reference to the hypothetical situation supra, if it is known that the catalyst will produce 60° C. of heat during hydrocracking, then the artisan is faced with the dilemma of using it or not. Using it runs the risk of reaching end of run temperature, which is significant.

Utilizing a new reactor designed specifically to sustain the temperature increase is feasible, but reactors must be designed with multiple beds and quench zones between the beds to address the heat generated, and need to be tested for other reasons known to the skilled artisan. Hence, while theoretically possible, the artisan in the field generally does not have the option of using a new reactor design.

A further option is the design of a new catalyst. For example, if the aforementioned catalyst has a zeolite content of, e.g., 60%, the artisan might consider lowering the zeolite content to 40%. Again, this is feasible, but may not be not practical if the catalyst with the desired composition is not readily available.

Generally, catalytic treatment of hydrocarbon feedstocks follow a well defined order. This order requires that single catalysts be loaded in reactor beds, based on their functionality.

The first catalyst is almost always a hydrometalization catalyst, i.e., a catalyst which functions to remove and to store any metal impurities in the hydrocarbon feedstock. This is necessary because metal impurities are detrimental to the further steps in the treatment of the hydrocarbons. These “HDM” catalysts typically have wide pore openings, and high pore volume, to permit storage of metals after the catalytic reaction removes them. Typically they comprise alumina or silica or combination thereof, and use Ni or molybdenum or combinations thereof for the hydrogenation reaction leading to removal of the metals.

In the invention described infra, HDM catalysts are not relevant and it should be assumed that one or more HDM catalyst may be used at the start of the reaction.

Following demetallization, the demetallized hydrocarbon feedstock contacts one or both of hydrodesulfurization and hydrodenitrogenation (“HDS” and “HDN” respectively) catalysts.

These catalysts usually contain Ni—Mo, Co—Mo, or Co—Ni—Mo on an alumina or silica/alumina support. These catalysts, as would be expected from their names, result in hydrocarbon feedstocks that are nearly free of nitrogen and sulfur. These HDS and HDN catalysts can also have the ability to hydrocrack the feedstock, as a result of high temperatures and supports resulting from the alumina (low or no acidity), or silica-alumina (which has low-medium acidity) support, and a strongly acidic zeolite.

Once the desulfurization and denitrogenation have occurred, the treated feedstock is ready to be hydrocracked by a catalyst which is usually silica-alumina or zeolite based and usually contains Ni—Mo or Ni—W to convert the feedstock.

Hydrocracking is known as an established, reliable and flexible method for transforming materials such as low-value heavy oil fractions into higher value products. Configuration, catalyst choices and operating conditions of the hydrocracking processes and apparatus used, offer flexibility in, e.g., the selection of feedstock, the products of the hydrocracking, operating efficiency, and profitability. Several process configurations are available, including but not being limited to, once-through (or series flow), two-stage, single stage, mild hydrocracking etc., with catalysts. The choice of catalysts and their layering are also important in adapting the general processes to produce the desired products.

Hydrocracking processes are used widely in, e.g., petroleum refineries. They are used to process a variety of feedstocks which usually boil in the range of 370° C. to 520° C. in conventional hydrocracking units, and boil at 520° C. and above in residue hydrocracking units. In general, hydrocracking processes split the molecules of the feed into smaller, i.e., lighter molecules, having higher average volatility and economic value.

Additionally, hydrocracking processes typically improve the quality of the hydrocarbon feedstock used by increasing the hydrogen to carbon ratio of the products of hydrocracking, and by removing organosulfur and/or organonitrogen compounds. The significant economic benefit derived from hydrocracking processes has resulted in substantial improvements of the process, and in more active catalysts.

Mild hydrocracking or single stage once-through hydrocracking, occurs at operating conditions that are more severe than standard hydrotreating processes, and which are less severe than conventional, full conversion or high pressure hydrocracking processes. Mild hydrocracking processes are more cost effective, but typically result in lower product yields and quality. They produce less middle distillate products of relatively lower quality, as compared to the products of conventional full conversion or high pressure hydrocracking processes.

Single or multiple catalytic systems can be used in these processes, depending upon the feedstock being processed and the product specifications. Single stage hydrocracking is the simplest of the various configurations, and is typically designed to maximize middle distillate yield over a single or multiple catalyst system. Multiple catalyst systems can be deployed, e.g., in stacked-bed configuration or in multiple reactors.

In a series-flow configuration, the entire hydrocracked product stream from the first reaction zone, including light gases (e.g., C₁-C₄ gases, H₂S, NH₃) and all remaining hydrocarbons, move to a second reaction zone. In the two-stage configuration the feedstock is refined by passing it over a hydrotreating catalyst bed in the first reaction zone. The effluents are passed to a fractionating zone to separate the light gases, naphtha and diesel products which boil at a temperature range of 36° C. to 370° C. Any hydrocarbons boiling above 370° C. pass to a second reaction zone for additional cracking.

Conventionally, most hydrocracking processes are used for production of middle-distillates, e.g., those molecules which boil at a range of from about 180° C. to about 370° C. and gasoline, e.g., those molecules which boil at a range of from about 36° C. (to about 180° C. after reforming processes.

In all of the above-described hydrocracking process configurations, cracked products, along with partially cracked and unconverted hydrocarbons, are passed to a distillation column for fractionation into products which may include naphtha, jet fuel/kerosene, and diesel fuel, which boil at nominal ranges of 36° C.-180° C., 180° C.-240° C. and 240° C.-370° C., respectively, and unconverted products which boil at temperatures above 370° C. Typical jet fuel/kerosene fractions (i.e., smoke point>25 mm) and diesel fractions (i.e., cetane number>52) are of high quality and exceed worldwide transportation fuel specifications. Although hydrocracking unit products have relatively low aromaticity, aromatics that do remain have lower key indicative properties (smoke point and cetane number).

In the above-described embodiments, the feedstocks generally include any liquid hydrocarbon feed conventionally suitable for hydrocracking operations, as is known to those of ordinary skill in the art. For instance, a typical hydrocracking feedstock is vacuum gas oil (VGO), which boils at temperatures of 370° C. to 520° C. Other intermediate refinery streams including demetalized oil (DMO) or de-asphalted oil (DAO), and coker gas oils from delayed coking units. Also, cycle oils from fluid catalytic cracking units can be blended with VGO or can be used “as is.” The hydrocarbon feedstocks can be derived from naturally occurring fossil fuels such as crude oil, shale oils, coal liquid, or from intermediate refinery products or their distillation fractions such as naphtha, gas oil, or combinations of any of the aforementioned sources.

The catalysts used in first and second stage hydroprocessing reaction zones typically contain one or more active metal components selected from IUPAC 4-10 of the Periodic Table of the Elements. In certain embodiments, the active metal component is one or more of cobalt, nickel, tungsten, molybdenum, or noble metals, such as platinum or palladium, typically deposited or otherwise incorporated on a support, e.g., alumina, silica-alumina, silica, titania or a zeolite or variations thereof which have been modified by, e.g., steam or acid treatment and/or insertion of metals into the zeolite structure.

The first stage process, referred to supra, hydrotreats the feedstock, essentially resulting in removal of nitrogen, sulfur, and sometimes metals contained in the feedstock molecules. Hydrocracking reactions which also take place in the first stage result in conversion of from 10-65 wt % of the feedstock. As compared to the first stage, second stage processing occurs at lower temperatures, the specifics of which will depend on the feedstock and the type of catalysts used. Exemplary conditions for both stages in these two stage processes include reaction temperatures of from 300° C. to 450° C., reaction pressures of from 80 to 200 bars, and hydrogen feed rates below 2500 SLt/Lt.

The catalysts used in the first and second stage may be the same, or different. Typically, a catalyst used in the first stage has an amorphous base (alumina or silica alumina), containing either Ni/Mo, Ni/W. There are, however, process configurations directed to conversion of up to 75 wt % of the feedstock. In such processes, a zeolite catalyst is preferably used. The second stage catalyst may be any of these as well.

To increase the efficiency and profitability of the process, the hydrocracking units are pushed to process heavier feed streams, whether they are deep cut VGO or some other feedstream coming from intermediate refinery processes, such as a coker, an FCC or residue hydroprocessing units. These heavy feedstocks are processed at the cost of reduced cycle length, higher hydrogen consumption, and/or low product yields and quality. New catalysts and/or optimum layering of catalysts are needed to increase the process performance, in addition to optimizing other process parameters, such as better liquid-gas distribution, reactor volume efficiency, etc.

Catalyst layering or loading is well known in the art. For a given objective, hydrocracking catalysts are loaded, based on their functionality, e.g., acidity, and content of active metals, such as Co—Mo (usually used for hydrodesulfurization). Ni—Mo (usually used for hydrodenitrogenation), or Pt/Pd (usually used for hydrogenation for sulfur/nitrogen free hydrocarbons). These practices require lengthy catalyst testing programs to optimize the catalyst layering in the fixed-bed reactor.

Examples of catalytic layering techniques may be seen in, e.g., Published PCT Application 2011/0079540 to Krishna, et al., incorporated by reference, which describes methodologies where waxy, hydrocarbon feedstocks are contacted to layered catalysts. U.S. Pat. No. 5,186,818 to Daage, et al., U.S. Pat. No. 7,387,712 to Furta, et al., U.S. Pat. No. 4,657,663 to Gardner, et al., and Published PCT Patent Application 2012/0111768 to Elsen, all describe layered catalyst systems.

Also see, e.g., Published PCT Application 1993/021284, U.S. Pat. Nos. 8,163,169; 7,686,949; 6,576,119; 6,086,749; 5,916,529; 5,439,860; 4,822,476; 3,793,190; and 3,617,490, as well as JP 2010163622; JP 2003171671; JP 11080753; and CN 101053846, all of which are incorporated by reference.

An example of a typical, layered catalytic system can be seen in FIG. 1. The figure shows three reactors “101,” “102,” and “103,” respectively. The reactors “101” and “102” are used for demetallization, desulfurization, and denitrogenation. An HDM catalyst is placed at the top of reactor “101.” This reactor has three reactor beds “101a”, “101b,” and “101c”. These three beds contain a catalyst which refines and both desulfurizes and denitrogenizes the feedstock.

Following the activity in reactor “101,” the product moves to reactor “102,” which also contains three beds “102a,” “102b,” and “102c.” This reactor continues the hydrocracking of lighter materials, and any resulting effluents move to fraction reactor “104,” while unreacted bottoms move to reactor “103” for further hydrocracking. This reactor has three beds “103a,” “103b,” and “103c,” each of which is loaded with a catalyst containing 50-70 w % zeolite, for further hydrocracking.

Each reactor contains layers of single unmixed catalyst. As discussed, reactor “101” contains a top layer of an HDM catalyst, and layers of an HDS/HDN catalyst. Reactor “102” contains an HDS/HDN catalyst capable of mild hydrocracking, and reactor “103” contains layers of a catalyst dedicated to hydrocracking.

It will be seen that the reactor beds are separated by quenching zones, indicated by empty space. The systems, and conventional catalysts used, are designed to and are capable of dispersing the heat of the catalytic reaction, which is about 25° C.

It may be desirable, however, for the artisan to use a catalyst in. e.g., reactor “102,” which has a higher zeolite content (e.g., about 30% or more), which yields an increase in heat that the rector unit cannot tolerate. There can be very many reasons for the artisan to want to use this theoretically unsuitable catalyst, including the composition of the feed, as well as the catalysts available. In such situations, the potential options of modifying the reactor or developing a new catalyst, are not in fact practical.

The inventors have now found that one can eliminate the problem of excess heat generation via combining the desired catalyst, which generates too much heat, with a catalyst of parallel function, which is not as efficient as the first catalyst, but which generates much less heat, without causing the yield of the process to drop to unacceptably low levels of efficiency.

The detailed description of preferred embodiments which follows elaborates upon various embodiments of the invention.

### BRIEF DESCRIPTION OF THE FIGURES

FIG. 1 shows a typical system of catalysts and reactors known to the art.

FIG. 2 shows a catalyst and reactor system in accordance with the invention where then layers of two catalysts are used while two are shown, more than two are possible.

FIG. 3 depicts an embodiment of the invention where the catalysts are mixed to form a uniform combination of two or more catalysts, while two are shown, more than two are possible.

### DETAILED DESCRIPTION OF PREFERRED EMBODIMENTS

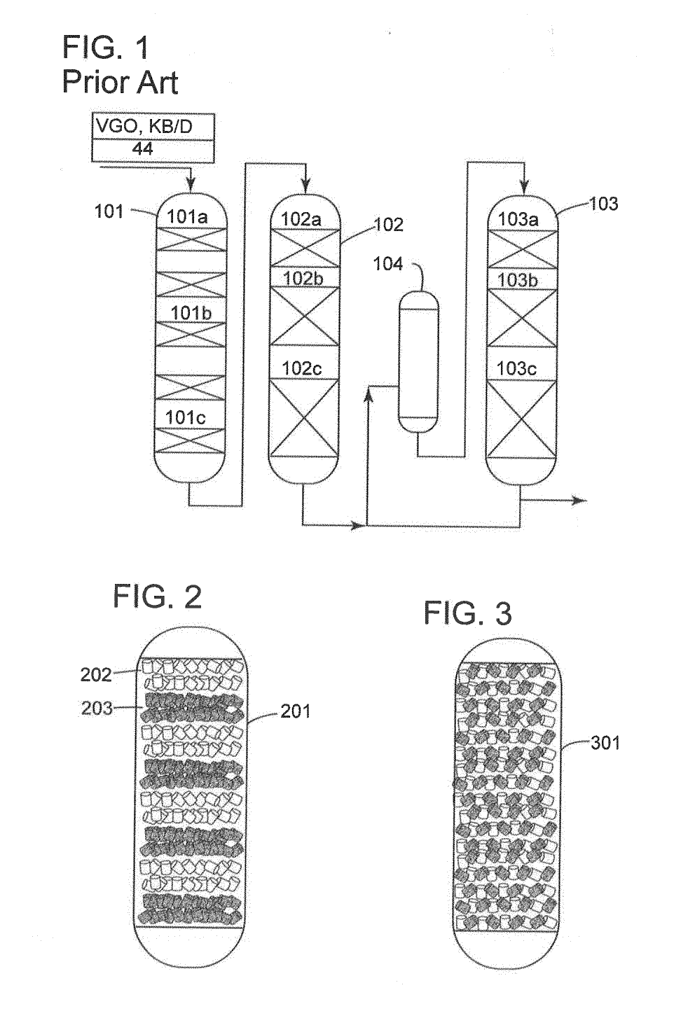

As noted, supra, the prior art shows the use of single catalysts, in reactor beds separated by quencher zones (FIG. 1). FIG. 2 shows a reactor 201, lacking quencher zones, in which alternating layers of catalysts are placed. These can be a zeolite catalyst and an amorphous catalyst (202 and 203), as described supra, or can include more than two catalysts, i.e., more than one amorphous catalyst, or more than one zeolite catalyst, or more than one of both.

In FIG. 3, reactor 301 contains a uniform mixture of the catalysts 202 and 203, discussed supra. As with the embodiment of FIG. 2, more than two different catalyst may be used.

### Example 1

A feedstock blend is hydrocracked in a first stage of a hydrocracker unit. The feedstock contained 15 V % demetalized oil (“DMO”), and 85 V % vacuum gas oil (“VGO”) of which 64% is heavy VGO (“HVGO”) and 21% is light VGO (“LVGO”). The feedstock had a specific gravity of 0.918 contained 2.2 wt % of sulfur, 751 ppmw nitrogen, and had a bromine number of 3.0 g/100 g feedstock. Other properties included 12.02 wt % hydrogen, an “IBP” (initial boiling point) of 210° C., a 10/30 of 344/411° C., a 50/70 of 451/498° C., a 90/95 of 595/655° C., and a 98 of 719° C.

The simulations were carried-out using in-house kinetic models, which were based on extensive pilot plant data spanning 440 days of operations. An amorphous catalyst was used in the process and the hydrogen partial pressure, LHSV are set at 115 bars 0.435 h⁻¹, respectively. In the simulations, the maximum delta T was set at 40° C. and the resultant conversion level and the required operating temperature are calculated. As seen, the temperature at the top bed is 396 and the bottom of the bed is 436° C. So with the amorphous catalyst the start-of-run (SOR) temperature at the top bed is 396° C. is needed to achieve the 47.2 V % conversion, which is close to the targeted 50 V % conversion.

The simulation reveals that a high operating temperature was necessary to achieve 47.1 V % conversion, which is close to 50 V %, within the acceptable delta temperature across the bed.

| | Temperature | Conversion | Delta T Cumulative |
|---|---|---|---|
| Bed# | ° C. | W % | ° C. |
| 1Top | 395 | 2.7 | 2.4 |
| 1Bot-2Top | 399 | 3.0 | 5.0 |
| 2Bot-3Top | 401 | 3.4 | 8.0 |
| 3Bot-4Top | 404 | 3.9 | 11.4 |
| 4Bot-5Top | 408 | 4.6 | 15.3 |
| 5Bot-6Top | 412 | 5.5 | 20.0 |
| 6Bot-7Top | 416 | 6.7 | 25.7 |
| 7Bot-8Top | 422 | 8.6 | 32.8 |
| 8Bot-9Top | 429 | 11.5 | 42.2 |
| 9Bot | 438 | 47.1 | 39.9 |

### Example 2

The simulation was repeated using a zeolite catalyst. The results which follow, show that a 49.6% conversion (very close to desired 50%), was achieved at a temperature of 375° C. at the top of the bed and 415° C. at the bottoms of the bed, significantly less than the 438° C. for the amorphous catalyst.

Similarly, the maximum delta T was set at 40° C. with the zeolitic catalysts. As seen, the SOR temperature at the top bed is 375° C. and the bottom of the bed is 415° C. So with the zeolitic catalyst the temperature requirement decreased substantially (21° C. less) to achieve the 49.6 V % conversion which is very close to 50 V % target. The heat can be managed as the SOR temperature is low. However, this catalyst is very sensitive to temperature changes as its activation energy is high, i.e., >50 Kcal/mol. Any slight increase in temperature will result in high heat release and the delta temperature across the reactor will exceed the maximum 40° C. limit. So this catalyst will not be recommended for this operation.

| | Temperature | Conversion, | Delta T Cumulative |
|---|---|---|---|
| Bed# | ° C. | W % | ° C. |
| 1Top | 375 | 1.5 | 1.3 |
| 1Bot-2Top | 376 | 1.7 | 2.8 |
| 2Bot-3Top | 378 | 2.0 | 4.6 |
| 3Bot-4Top | 380 | 2.4 | 6.7 |
| 4Bot-5Top | 382 | 3.0 | 9.3 |
| 5Bot-6Top | 384 | 4.0 | 12.7 |
| 6Bot-7Top | 388 | 5.7 | 17.6 |
| 7Bot-8Top | 393 | 9.2 | 25.2 |
| 8Bot-9Top | 400 | 19.0 | 40.0 |
| 9Bot | 415 | | |
| | 40.0 | 48.6 | |

### Example 3

In this example, a 50/50 blend of the amorphous and zeolite catalysts of the first two examples was used. Again, the conditions of Example 1 were used. The results show a temperature increase of 10° C. at the top of the bed versus the zeolite (375° C. vs. 385° C.), and a 10° C. increase at the bottom of the bed (415° C. versus 425° C.), to achieve a 47.5% conversion.

Similarly, the maximum delta T was set at 40° C. with the zeolitic/amorphous catalysts. As seen, the temperature at the top bed is 385° C. and the bottom of the bed is 425° C. So with the blend catalysts system the temperature requirement increased by 10° C. to achieve the 48.6 V % conversion which is very close to 50 V % target compared to the pure zeolitic system and the heat in the reactor can be managed:

| | Temperature | Conversion | Delta T Cumulative |
|---|---|---|---|
| Bed# | ° C. | W % | ° C. |
| 1Top | 385 | 2.2 | 1.9 |
| 1Bot-2Top | 387 | 2.5 | 4.1 |
| 2Bot-3Top | 389 | 2.8 | 6.5 |
| 3Bot-4Top | 392 | 3.3 | 9.3 |
| 4Bot-5Top | 395 | 3.9 | 12.7 |
| 5Bot-6Top | 398 | 4.9 | 16.9 |
| 6Bot-7Top | 402 | 6.3 | 22.2 |
| 7Bot-8Top | 408 | 8.7 | 29.5 |
| 8Bot-9Top | 415 | 13.0 | 40.0 |
| 9Bot | 425 | | |
| | 40.0 | 47.5 | 40 |

This clearly shows that the zeolitic catalysts are much more active than the amorphous catalysts and the heat generated from a blended catalyst system can be managed easily.

### Example 4

Finally, a system using a stacked bed of amorphous/zeolite was used, rather than a mix.

The results follow, and show a necessary starting temperature of 377° C., very close to the pure zeolite system, and an ending temperature of 417° C., to 48.8 W % of the feedstock.

These results also show that most of the conversion takes place with the zeolite catalyst.

Similarly, the maximum delta T was set at 40° C. with the zeolitic/amorphous stacked bed catalysts (50:50 V %). As seen, the temperature at the top bed is 377° C. and the bottom of the bed is 417° C. So with the stacked bed catalysts system the temperature requirement is close to the zeolitic system to keep the delta temperature at max level, 40° C. to achieve the 48.6 V % conversion which is very close to 50 V % target compared to the pure zeolitic system. As seen, the amorphous catalyst system is underutilized as most of the conversion is taking place on the zeolitic catalysts. If both catalysts need to be utilized to benefit from both catalysts, different reactors must be used and run at different temperatures: 1^{st} reactor with amorphous catalysts operating at higher temperature and 2^{nd} reactor operating at lower temperature, which means 1^{st} reactor effluents must be cooled down.

| | Temperature | Conversion | |
|---|---|---|---|
| Bed# | ° C. | W % | Delta T Cumulative |
| 1Top | 377 | 1.2 | 1.1 |
| 1Bot-2Top | 378 | 1.3 | 2.2 |
| 2Bot-3Top | 379 | 1.4 | 3.5 |
| 3Bot-4Top | 381 | 1.5 | 4.8 |
| 4Bot-5Top | 382 | 1.6 | 6.1 |
| 5Bot-6Top | 383 | 4.2 | 9.7 |
| 6Bot-7Top | 387 | 6.0 | 14.8 |
| 7Bot-8Top | 392 | 10.0 | 23.1 |
| 8Bot-9Top | 400 | 21.7 | 39.6 |
| 9Bot | 417 | | |
| | 39.6 | 48.8 | |

What the results show in addition to the data tables presented, if one seeks the benefits of both catalysts, different reactors are needed, because the very high temperatures needed for the amorphous catalyst, require quenching or cooling of the products before they are applied to the zeolite catalyst.

Other features of the invention will be clear to the skilled artisan and need not be reiterated here.

The terms and expression which have been employed are used as terms of description and not of limitation, and there is no intention in the use of such terms and expression of excluding any equivalents of the features shown and described or portions thereof, it being recognized that various modifications are possible within the scope of the invention.

We claim:

1. A method for dispersing heat generated by a catalytic reaction comprising, combining at least two catalyst which have different activity temperatures and same functions in a catalysts being combines in a ratio sufficient to maintain an end of run temperature below a tolerance temperature of said reactor.

2. The method of claim 1, comprising admixing said at least two catalysts to form a uniform composition.

3. The method of claim 1, comprising providing a plurality of individual layers of said at least two catalysts in said catalytic reactor.

4. The method of claim 1, wherein said at least two catalysts are hydrocracking catalysts.

5. The method of claim 1, wherein at least one of said catalysts is an amorphous based catalyst, and at least one of said catalysts is a zeolite based catalyst.

6. The method of claim 5, wherein said amorphous based catalyst contains Ni and Mo or Ni and W.

7. The method of claim 1, wherein at least one of said at least two catalysts contains Co and Mo, Ni, and Mo, or Pt and Pd.

8. The method of claim 1, wherein said at least two catalysts are present in a range from 1/99 to 99/1 ratio.

9. The method of claim 8, wherein said at least two catalysts are an amorphous catalyst and a zeolite catalyst.
The method of claim 1, wherein said catalytic reactor has a tolerance of from 25° C. to 40° C. higher than said activity temperature for one of said at least two catalysts having highest activity temperature of said at least two catalysts.
